(19) United States
(12) Patent Application Publication
(10) Pub. No.: US 2009/0263184 A1
(43) Pub. Date: Oct. 22, 2009

(54) Adapter For Connecting A Faucet Mounted Water Faucet Filter To A Water Faucet

(76) Inventors: Richard Paul Riedel, Mason, OH (US); Brian David Andres, Harrison, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/425,410

(22) Filed: Apr. 17, 2009

Related U.S. Application Data
(60) Provisional application No. 61/045,858, filed on Apr. 17, 2008.

(51) Int. Cl. F16L 25/00; F16D 1/00

(52) U.S. Cl. 403/301; 403/299

(57) ABSTRACT

An adaptor includes a body, a threaded end connected to the body for threadingly engaging an end of a water faucet, a flanged end connected to the body, opposite the threaded end for receiving a quick connect device on a faucet-mounted water filter system, a water inlet disposed within the body at the threaded end, the water inlet comprising a first inlet chamber and an second inlet chamber in fluid communication with the first inlet chamber, a water outlet disposed within the body at the flanged end, a plurality of outer flow channels coaxially-aligned with a longitudinal axis of body 12, the plurality of outer flow channels connecting in fluid communication the first inlet chamber with the outlet, and a plurality of inner flow channels that are coaxially-aligned with the longitudinal axis, the plurality of inner flow channels connecting in fluid communication the second inlet chamber with the outlet, wherein the plurality of inner flow channels are substantially concentric with the plurality of outer flow channels. The adaptor may also include a plurality of gripping areas disposed along a circumference of the body, wherein the plurality of gripping areas provides visual and tactile directional signals as to the rotational direction required to attach or detach the adaptor to or from a threaded member. The gripping areas may be asymmetrical or unidirectional in order to provide visual and tactile signals as to the rotational direction to connect the adaptor to a water faucet.

### CROSS REFERENCE TO RELATED APPLICATIONS

This application claims the benefit of U.S. Provisional Application No. 61/045,858, filed Apr. 17, 2008.

### FIELD OF THE INVENTION

The present invention relates generally to an adaptor for connecting a faucet mounted water filter to a water faucet. More particularly, the present invention relates to an adaptor for connecting a faucet mounted, quick connect water filter to a water faucet, wherein the adaptor includes a flow straightening device. Even more particularly, the present invention relates to an adaptor for connecting a faucet mounted, quick connect water filter to a water faucet, wherein the adaptor includes finger gripping areas along an outer surface to be used during threading the adaptor onto an end of the faucet, and wherein the finger gripping areas provide visual and tactile signals as to the correct rotational direction for attachment.

### BACKGROUND OF THE INVENTION

Water faucets positioned at a sink such as a kitchen sink generally have threaded ends for receiving faucet mounted water filter systems. Typically, the faucet mounted water filter systems include a threaded opening for threadingly engaging the threaded end of the water faucet in order to connect the water filter system to the faucet end. Generally, these openings comprise a symmetrical nut design rotatably connected to the filter system. These systems require a user to hold the filter system while simultaneously aligning and threading the nut onto the end of the faucet.

Accordingly, an improved connection design and method for connecting a water faucet mounted filter system to a water faucet.

### SUMMARY OF THE INVENTION

The present invention is directed to an adaptor for connecting a water filter system to a water faucet.

One embodiment of the present invention is an adaptor includes a body, threaded end connected to the body for threadingly engaging an end of a water faucet, a flanged end connected to the body, opposite the threaded end for receiving a quick connect device on a faucet-mounted water filter system, a water inlet disposed within the body at the threaded end, the water inlet comprising a first inlet chamber and an second inlet chamber in fluid communication with the first inlet chamber, a water outlet disposed within the body at the flanged end, a plurality of outer flow channels coaxially-aligned with a longitudinal axis of body 12, the plurality of outer flow channels connecting in fluid communication the first inlet chamber with the outlet, and a plurality of inner flow channels that are coaxially-aligned with the longitudinal axis, the plurality of inner flow channels connecting in fluid communication the second inlet chamber with the outlet, wherein the plurality of inner flow channels are substantially concentric with the plurality of outer flow channels.

Another embodiment of the present invention is an asymmetrical adaptor for attaching a water filter system to a water supply that includes a body, wherein the body is asymmetrical with respect to any plane that contains the longitudinal axis of the adaptor body, a plurality of unidirectional gripping areas circumferentially positioned along a perimeter of the body, a threaded end connected to the body for threadingly engaging an end of a water supply, a flanged end connected to the body, opposite the threaded end for receiving a quick connect device on a faucet-mounted water filter system, a water inlet disposed within the body at the threaded end, and a water outlet disposed within the body at the flanged end and in fluid communication with the water inlet.

Yet another embodiment of the present invention is an adaptor that includes an annular body, a threaded end connected to the body for threadingly engaging an end of a water faucet, a flanged end connected to the body, opposite the threaded end for receiving a quick connect device on a faucet-mounted water filter system, a water inlet disposed within the body at the threaded end, an inlet chamber coaxially disposed within the annular body, a plurality of outer ribs extending radially inwardly from the annular body to the water inlet chamber forming a plurality of outer flow channels, a plurality of ribs disposed at an exit end of the inlet chamber forming a plurality of inner flow channels, and an outlet disposed at the flanged end of the body, wherein the plurality of outer flow channels connect in fluid communication the inlet to the outlet, and wherein the plurality of inner flow channels connect in fluid communication the inlet chamber with the outlet.

One embodiment of the present invention is a method for a method for providing an adaptor with visual and tactile signals for attaching the adaptor to a threaded member that includes providing an adaptor body and forming a plurality of unidirectional gripping areas along a circumference of the body such that the plurality of gripping areas provides visual and tactile directional signals as to the correct rotational direction required to attach the adaptor to a threaded member.

### BRIEF DESCRIPTION OF THE DRAWINGS

While the specification concludes with claims particularly pointing out and distinctly claiming the invention, it is believed the same will be better understood from the following description taken in conjunction with the accompanying drawings in which:

FIG. 1 is a perspective view of an exemplary adaptor according to an embodiment of the present invention;

FIG. 2 is a bottom planar view of the exemplary adaptor according to FIG. 1;

FIG. 3 is a top planar view of the exemplary adaptor according to FIG. 1;

FIG. 4 is a cross sectional view of the exemplary adaptor taken along A-A of FIG. 2;

FIG. 5 is a cross section view of the exemplary taken along B-B of FIG. 2;

FIG. 6 is a cross section view of the exemplary taken along C-C of FIG. 4;

FIG. 7 is a perspective view of an exemplary adaptor according to an embodiment of the present invention;

FIG. 8 is a top planar view of the exemplary adaptor according to FIG. 7;

FIG. 9 is a bottom planar view of the exemplary adaptor according to FIG. 7;

FIG. 10 is a cross sectional view of the exemplary adaptor taken along A-A of FIG. 8;

FIG. 11 is a cross section view of the exemplary taken along B-B of FIG. 8;

FIG. 12 is a cross section view of the exemplary taken along C-C of FIG. 11;

FIG. 13 is a perspective view of an exemplary adaptor according to an embodiment of the present invention;

FIG. 14 is a top planar view of the exemplary adaptor according to FIG. 13;

FIG. 15 is a bottom planar view of the exemplary adaptor according to FIG. 13;

FIG. 16 is a cross sectional view of the exemplary adaptor taken along A-A of FIG. 15;

FIG. 17 is a cross section view of the exemplary taken along B-B of FIG. 16;

FIG. 18 is a cross section view of the exemplary taken along C-C of FIG. 16;

FIG. 19 is a perspective view of an exemplary adaptor according to an embodiment of the present invention;

FIG. 20 is a top planar view of the exemplary adaptor according to FIG. 19;

FIG. 21 is a bottom planar view of the exemplary adaptor according to FIG. 19;

FIG. 22 is a cross sectional view of the exemplary adaptor taken along A-A of FIG. 21;

FIG. 23 is a cross section view of the exemplary taken along B-B of FIG. 22; and

FIG. 24 is a cross section view of the exemplary taken along C-C of FIG. 22.

The embodiments set forth in the drawings are illustrative in nature and not intended to be limiting of the invention defined by the claims. Moreover, individual features of the drawings and the invention will be more fully apparent and understood in view of the detailed description.

### DETAILED DESCRIPTION OF THE INVENTION

Reference will now be made in detail to various embodiments of the invention, examples of which are illustrated in the accompanying drawings, wherein like numerals indicate similar elements throughout the views.

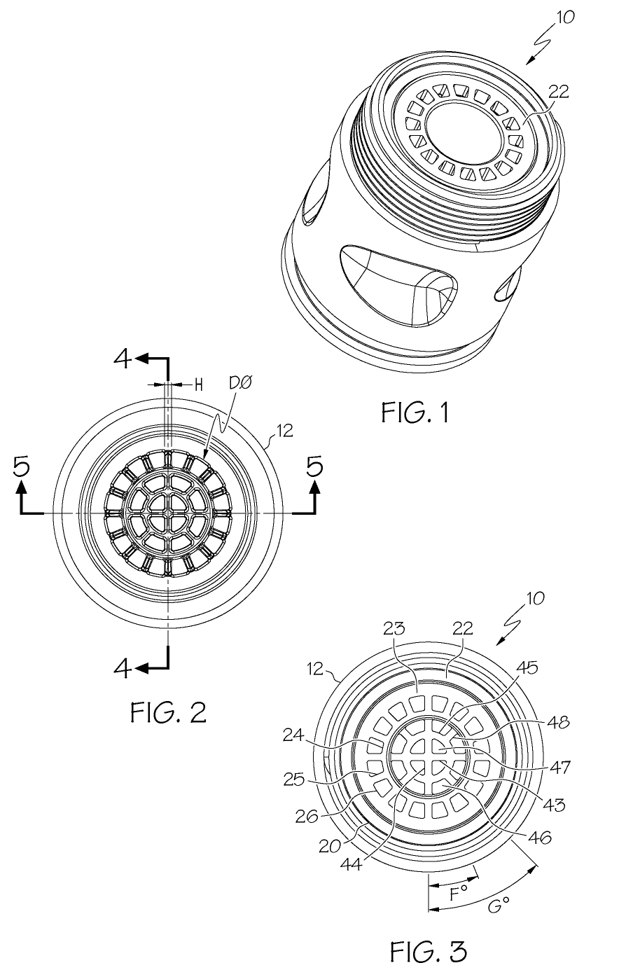

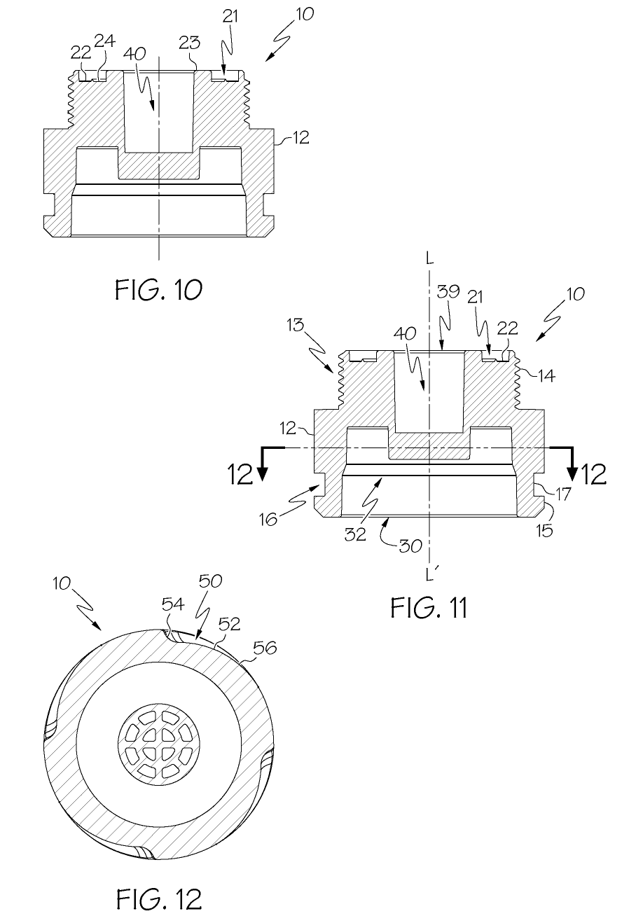

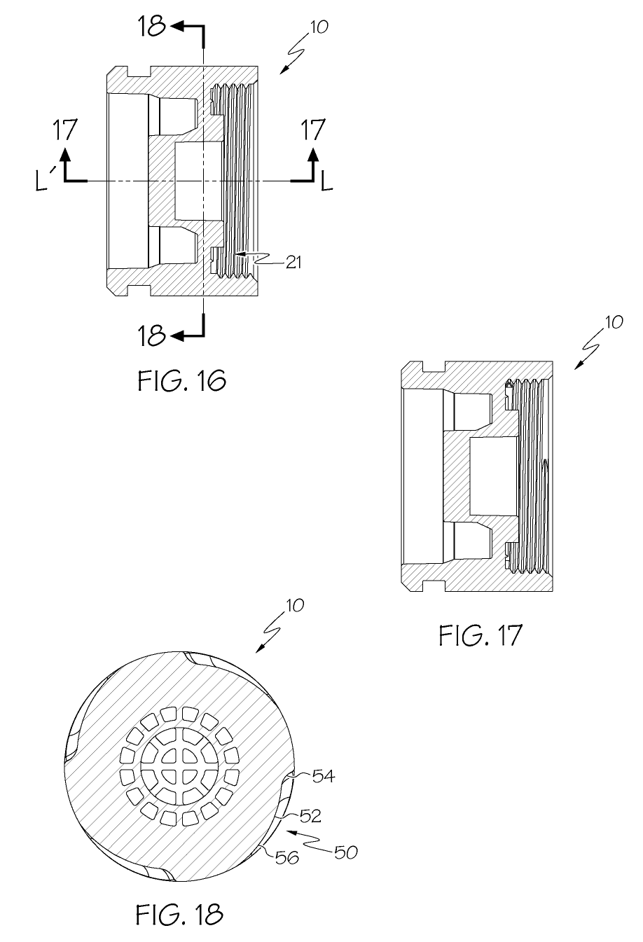

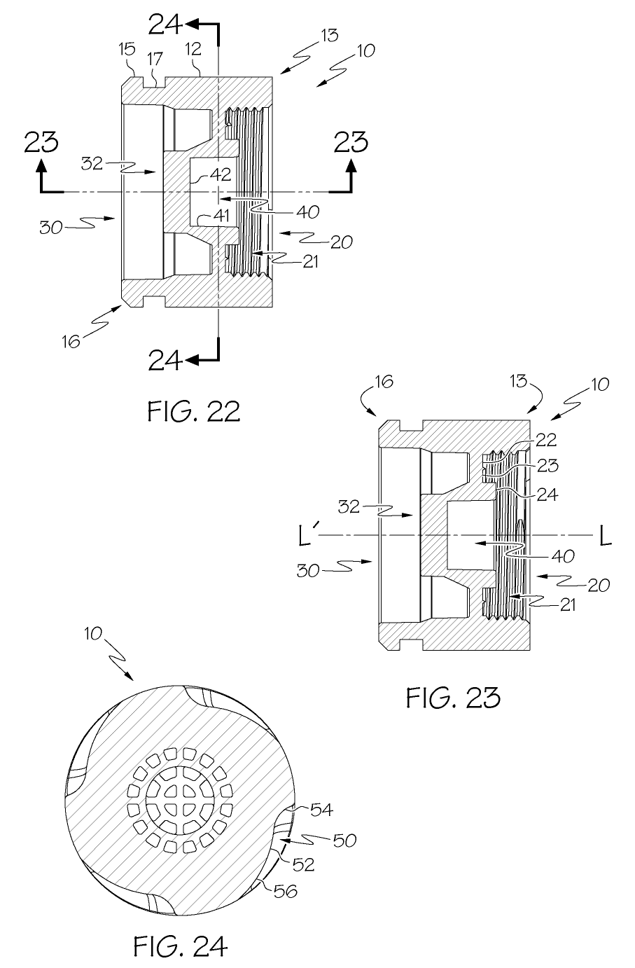

The present invention an adaptor for connecting a faucet-mounted water filter system to a water faucet, wherein the filter system includes a quick connect/disconnect device that connects/disconnects the filter system to and/or from the adaptor. FIGS. 1-24 therefore show an exemplary embodiment of the adaptor of the present invention generally as 10. Adaptor 10 may comprise an annular body 12 having a threaded end 13, a flanged end 16, external side wall 18, interior surface 11, and a longitudinal axis L-L′.

Adaptor body 12 may be fabricated using any conventional methods such as compression or injection molding and/or machining from a variety of conventional materials, including but not limited to metals, plastics such as polymers (e.g., acrylonitrile butadiene styrene (ABS), polycarbonate, polyethylene), composite materials, or any combination thereof as known to one of ordinary skill in the art.

Threaded end 13 may comprise external threading 14 disposed within body 12. Threaded end 13 may be threadingly engaged to a threaded end (internal threaded) of a water faucet, e.g., a water faucet positioned at a kitchen sink. As set forth below herein in alternative exemplary embodiments, threaded end 13 may comprise internal threading disposed within body 12 in order to threadingly engage an external threaded end of a water faucet as known to one of ordinary skill in the art. Threads 14 may also comprise any conventional threading and be fabricated from a variety of materials such as metal, plastics (e.g., polymers), composite materials, or any combination thereof as known to one of ordinary skill in the art. Also, threads 14 may be part of an insert that is installed within and connected to aperture 10 or formed as an integral part of the aperture itself. Threading 14 of adaptor 10 is configured such that adaptor 10 may be threadingly connected or attached to an end of a conventional faucet in order to mounted and connect a faucet-mounted water filter system to flange end 16 of the adaptor, placing the water filter system in fluid communication with the water faucet.

Although not required, adaptor 10 may also include a gasket or seal (not shown) that is configured to make the adaptor connection to the faucet waterproof or leak proof and/or a aerator (not shown) to provide aeration to the water flowing from the adaptor as known to one of ordinary skill in the art. It is understood that this and other examples shown and described herein are used for illustration purposes, and not limitation. It is also understood that adaptor 10 may be used to connect other devices such as other water devices such as a sprayer to water supplies such as a hose, pump, etc. as known to one of ordinary skill in the art.

Flanged end 16 may comprise a flange 15. In this exemplary embodiment, flange 15 is defined by a channel 17 disposed within body 12 adjacent to flange 15. However, it is understood that flange 15 may be fabricated such that flange 15 extends radially from external surface 18 such that body 12 does not include channel 17. Flange 15 and/or channel 17 are configured to receive, engage, and connect to a quick connect/disconnect device on a faucet-mounted water filter system. In one exemplary embodiment, flange end 16 is inserted into an inlet of the quick connect/disconnect device such that one or more spring-biased locking mechanisms slide past flange 15, and then spring and/or lock into place in channel 17, securing and connecting the faucet-mounted water filter system onto adaptor 10. If the now connected adaptor is connected to a water faucet, then the faucet-mounted water filter system is connected by adaptor 10 to the water faucet end. The quick connect/disconnect device also includes one or more actuators for moving (disengaging) the locking mechanism(s) out of channel 17, thus permitting the faucet-mounted water filter system to be quickly and efficiently removed from the end of the faucet.

Adaptor 10 may also comprise a water inlet 20 positioned at threaded end 13 and a water outlet 30 positioned at flanged end 16. When adaptor 10 is connected to an end of a water faucet, water inlet 20 receives water from the faucet end and directs it into the adaptor toward water outlet 30. As shown in FIGS. 1, 4, and 5, inlet 20 may comprise a first inlet chamber 21 and a second inlet chamber 40 concentric to and coaxially-aligned with annular body 12. In this particular exemplary embodiment, first inlet chamber 21 has a partial bottom wall 22 that extends transverse to the water flow path within adaptor 10. Also, second inlet chamber 40 comprises an entrance 29 that is disposed within bottom wall 22 such that entrance 39 is substantially flush with a surface of bottom wall 22, creating second inlet chamber 40 to be sequential to first inlet chamber 21 along the water flow path. In other words, when water enters inlet 20, it will flow through first inlet chamber 21 before flowing into second inlet chamber 40. In certain exemplary embodiments, this configuration may cause first and second inlet chambers 21 and 40 to function substantially like a funnel (i.e., creating a funneling action).

Outlet 3 may comprise an outlet chamber 32 disposed within annular body 12 of adaptor 10. Bottom wall 22 may comprise outer flow channels 26 that connect in fluid communication first inlet chamber 21 with outlet chamber 32, and thus ultimately inlet 20 with outlet 30. Specifically, in the exemplary embodiment shown in FIGS. 1-6, bottom wall 21 may be comprised of an outer annular rib 23 that is transverse to the water flow path and extends radially inwardly from interior surface 11, an inner annular rib 24 that is also transverse to the water flow path and is concentric and coaxially-aligned with outer annular rib 23, and one or more outer radial ribs 25 extending radially between outer annular rib 23 and inner annular rib 24.

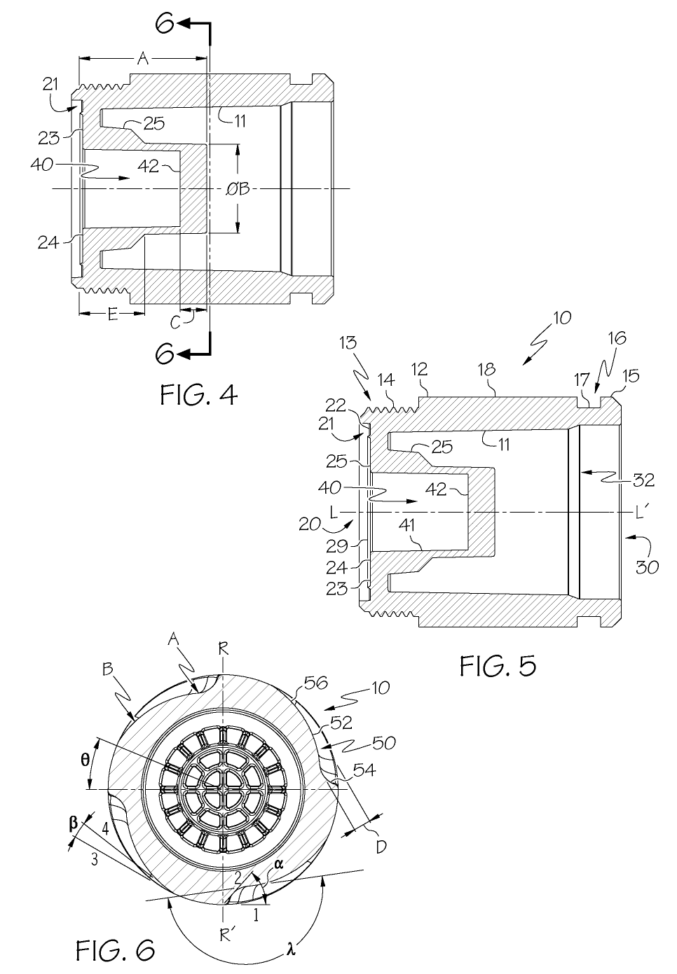

Inlet 20, in the exemplary embodiment, comprises sixteen (16) outer radial ribs 27 equally spaced about and coaxially-aligned with longitudinal axis L-L′. As shown in FIGS. 4 and 5, outer radial ribs 27 also extend longitudinally a length (E) within adaptor 10. As such, outer annular rib 23, inner annular rib 24, and outer radial ribs 25 form outer flow channels 26. Thus, since there are sixteen (16) outer radial ribs, adaptor 10, in this embodiment, comprises sixteen (16) outer flow channels 26 that are also equally spaced about and coaxially-aligned with longitudinal L-L′. It has been found that the length (E) of the outer radial ribs 25, and thus the length of outer flow channels 26, in some embodiments, has an impact on the water flow straightening capabilities of the adaptor 10. In one exemplary embodiment, length (E) of outer radial ribs 25 may comprise from about 1.0 mm to about 40 mm, from about 2.5 mm to about 35 mm, and/or from about 5 mm to about 30 mm. In another exemplary embodiment, length (E) may be equivalent to or substantially the same length at the length of adaptor 10 such that outer flow channels run substantially the entire length of adaptor 10.

As shown, outer flow channels 26 may comprise a substantially quadrilateral shape, wherein two of its sides may be formed by outer annular rib 23, inner annular rib 24, and two adjacent outer radial ribs 25 positioned on either side of outer flow channel 26. It is understood that outer flow channels 26 may comprise any shape, length, and/or configuration and that the shapes, lengths, and/or configurations described and shown herein are for illustrations purposes only, and not limitation.

In addition, second inlet chamber 40 comprises an annular interior side wall 41 and a bottom wall 42 connected to interior side wall 41. Bottom wall 42 may comprise a depth (C) as shown in FIG. 4. Adaptor 10 may comprise one or more inner flow channels such as, for example, one or more first inner flow channels 46 and one or more second inner flow channels 47 that connect in fluid communication second inlet chamber 40 with outlet chamber 32. As such, first and second inner flow channels 46 and 47 connect in fluid communication inlet 20 with outlet 30. In the exemplary embodiment shown, bottom wall 42 may be comprised of a first long rib 43, a second long rib 44 that is perpendicular to the first long rib, an annular rib 45 concentric to outer flow channels 26 and coaxially-aligned with longitudinal axis L-L′, and four (4) short radial ribs 48 each equally spaced ninety (90) degrees apart from one another and forty-five (45) degrees offset from first long rib 43 and second long rib 44 about longitudinal axis L-L′. Short radial ribs 48 extend radially from interior surface 41 to annular rib 45. First and second long ribs 43 and 44 each span the entire diameter of second inlet chamber 40 and intersect at longitudinal axis L-L′.

In addition, annular rib 45 intersects first long rib 43 at two points, each point positioned about one-fourth (¼) of its length from the interior side wall 41. Also, annular rib 45 intersects second long rib 44 at two points, each point positioned about one-fourth (¼) of its length from the interior side wall 41. In this exemplary embodiment, first and second long ribs 43 and 44, annular rib 45, and short radial ribs 48 form eight (8) substantially quadrilateral-shaped first inner flow channels 46 equally spaced about and coaxially-aligned with longitudinal axis L-L′, and four (4) substantially triangular-shaped, second inner flow channels 47 equally spaced about and coaxially-aligned with longitudinal axis L-L′ as well. Second inner flow channels 47 are interior to the eight (8) first inner flow channels 46 and thus are concentric to and coaxially-aligned with the eight (8) first inner flow channels 46 about longitudinal axis L-L′. With regard to the second inner flow channels 47, first long rib 43 forms substantially a first side of the triangle, second long rib 44 forms substantially a second side, and annular rib 45 forms substantially a third side of the triangle. Additionally, first and second inner flow channels 46 and 47 may connect in fluid communication second inlet chamber 40 to outlet chamber 32.

It has been found, in certain embodiments, that the depth (C) of bottom wall 42 (which is the same as the depth of first long rib 43, second long rib 44, annular rib 45, and/or short radial ribs 48), which essentially defines the length of first and second inner channels 46 and 47, respectively, has an impact on the water flow straightening capabilities of the adaptor 10. In one exemplary embodiment, depth (C) of bottom wall 42 may comprise from about 0.25 mm to about 40 mm, from about 0.5 mm to about 35 mm, from about 0.75 mm to about 30 mm, and/or from about 1.0 mm to about 20 mm. In another exemplary embodiment, depth (C) may be equivalent to or substantially the same length as the length of adaptor 10 such that first and second inner flow channels 46 and 47 run substantially the entire length of adaptor 10.

It is understood that first and second inner flow channels 46 and 47 may comprise the same or substantially the same number, shape, size, and/or configuration as one another and may comprise a variety of different number, shapes, sizes, and/or configurations. As shown, the entrances to the inner flow channels 46 and 47 are substantially flush with bottom wall 42 as shown in FIGS. 4 and 5. However, it is also understood that the entrances and/or the flow channels can be extended longitudinally toward inlet 20 such that the channels are no longer flush with bottom wall 42.

When adaptor 10 is threadingly connected to an end of a water faucet and the water is turned on, water will exit the water faucet into first inlet chamber 21 via inlet 20, the water flow may split into two flow paths: one, a portion may flow into and through outer flow channels 26 to outlet chamber 32; and two, a portion may flow into second inlet chamber 40, through first and second inner flow channels 46 and 47 into outlet chamber 32. After which, the water may flows through outlet chamber 32 and exit adaptor 10 via outlet 30. This dual flow path may happen sequentially and/or simultaneously. One or more of outer inlet chamber 21, second inlet chamber 40, outlet chamber 32, outer flow channels 26, and/or first and second inner flow channels 46 and 47 straighten or assist in straightening the stream of water that exits from outlet 30 of the adaptor. This flow straightening function of the adaptors internal design prevents users from getting sprayed with water when the faucet-mounted filter system is not connected to the adaptor, i.e., connected to the faucet, but the adaptor is still connected to the faucet.

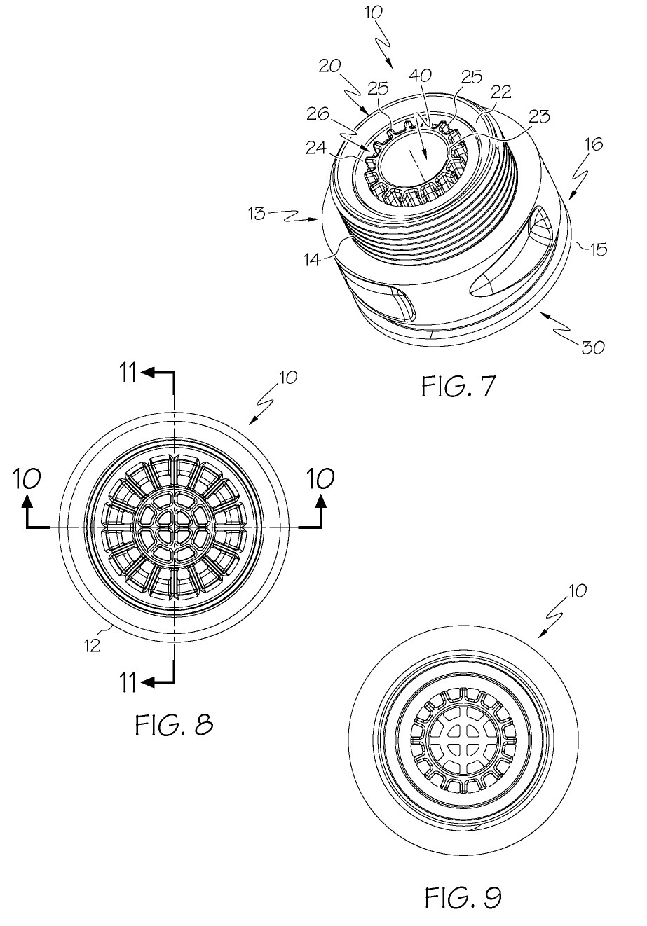

It understood that adaptor 10 may comprise other variations of outer flow channels 26 such as wherein certain sides of the flow channels extend axially from bottom wall 22 toward inlet 20 (e.g., see FIG. 7). As another example, adaptor 10 may comprise any number of outer flow channels 26 disposed in bottom wall 22, such as, for example, four (4) flow channels 26 evenly spaced about longitudinal axis L-L′ or eight (8) flow channels 26 evenly spaced about longitudinal axis L-L′.

In one or more exemplary embodiments, adaptor 10 may comprise the range of dimensions as set forth below and shown in FIG. 5. Dimensions A, B, C, D, E, F, G, and H are dimensions of specific portions of adaptor 10 as shown in FIG. 5. Dimension (A) is a length of second inlet chamber 40. Dimension (A) may comprise from about 2.5 mm to about 40 mm, from about 5.0 mm to about 30 mm, and/or from about 10 mm to about 26 mm. In another exemplary embodiment, dimension (A) may be the same or substantially the same as the entire length of adaptor 10. Thus, second inlet chamber 40 may run substantially the entire length of adaptor 10. Dimension (B) is the diameter of the second inlet chamber 40. Dimension (B) may comprise from about 2.5 mm to about 30 mm, from about 5.0 mm to about 25 mm, from about 10 mm to about 18 mm, and/or from about 12 mm to about 16 mm. Dimension (C) is a depth of bottom wall 42 as set forth above herein. Dimension (D) is the diameter of first inlet chamber 21. Dimension (D) may comprise from about 2.5 mm to about 30 mm, from about 5.0 mm to about 25 mm, from about 10 mm to about 20 mm, and/or from about 12 mm to about 18 mm. Dimension (E) is a length of outer radial rib 25 as set forth above herein. Dimension (F) is an angle the first outer radial rib 25 is offset from an outer radial rib 25 positioned in a vertical orientation. Dimension (F) may comprise from about 0 degrees to about 90 degrees, from about 0 degrees to about 60 degrees, or from about 0 degrees to about 30 degrees. Dimension (G) is an angle the first short radial rib 48 is offset from second long radial rib 44. Dimension (G) may comprise from about 0 degrees to about 90 degrees or from about 0 degrees to about 60 degrees. Dimension (H) is a width of outer radial rib 25. Dimension (H) may comprise from about 0.25 mm to about 5 mm, from about 0.5 mm to about 3 mm, from about 0.5 mm to about 2 mm, and/or from about 0.7 mm to about 1.8 mm. It should be understood that these ranges are shown for illustration purposes only, and not limitation. As such, it is conceived that other exemplary embodiments of the present invention may comprise dimensions outside of these disclosed ranges.

In the exemplary embodiment shown in FIGS. 1-6, body 12 of adaptor 10 may also comprise one or more gripping areas 50 disposed within body 12 about longitudinal axis L-L′. As shown in FIG. 6, gripping areas 50 comprise a surface 52, a pressure bearing face 54, and a non-pressure bearing face 56. Surface 52 may be fabricated from the same material as the body or a separate material such a low durometer plastic. A low durometer plastic may be desirable for at least a portion of surface 52 in order to provide a soft touch or feel to a user when making contact or gripping adaptor 10. An exemplary plastic that may be used to partially cover or fabricate surface 15 may comprise a low durometer elastomer.

Referring to FIG. 6, pressure bearing face 54 may comprise an angle of leverage α and non-pressure bearing face 56 may comprise an angle of leverage β. Angle of leverage α is measured from a hypothetical line 1 that is tangent to circumferential surface 11 and a hypothetical line 2 that is tangent to the slope of the initial curvature (conic, spherical or linear) defining face 54. Angle of leverage β is measured from a hypothetical line 3 that is tangent to circumferential surface 11 and a hypothetical line 4 that is tangent to the slope of the initial curvature (conic, spherical or linear) defining face 56. In the present invention, angle of leverage α may range from about 10 degrees to about 90 degrees, and angle of leverage β may range from about 0 degrees to about 90 degrees. The angle of leverage (α and β) defines the angle of the face (e.g., pressure bearing face 54 or non-pressure bearing face 56) available to make contact with a user's hand or fingers when attempting to grip and turn the adaptor. For example, the greater the angle of leverage (the closer the angle is to 90 degrees), the greater the slope of the face and thus the more face that is available for the user's hand or fingers to apply pressure against. As used herein, a “non-pressure bearing face” is defined as a face that has an angle of leverage (e.g., angle β) that is less than the angle of leverage (e.g., angle α) of an adjacent pressure bearing face of the same adaptor.

In the exemplary embodiment set forth in FIG. 6, non-pressure bearing face 56 has an angle of leverage β that is less than the angle of leverage α of pressure bearing face 54, thus forming face 56 into the non-pressure bearing face. In the exemplary embodiment, angle of leverage α may range from about 30 degrees to about 90 degrees (e.g., about 60 degrees) and angle of leverage β may range from about 10 degrees to about 60 degrees (e.g., about 30 degrees). It is understood that the angle of leverage may comprise an angle greater than 90 degrees in other alternative embodiments. As shown in FIG. 6, pressure bearing faces 54 and non-pressure bearing faces 56 cause adaptor 10 and gripping areas 50 to have an asymmetrical shape relative to any plane (e.g., R-R′) that contains the longitudinal axis L-L′ of adaptor 10.

It has been discovered that since adaptor 10 includes gripping areas 50 that comprise a pressure bearing face 54 and a non-pressure bearing face 56 (i.e., angle β is less than angle α), adaptor 10 provides a user both visual and tactile signals as to which rotational direction is the correct direction such as which rotational direction is required to threadingly connect adaptor 10 onto a water faucet end. It is understood that adaptor 10 may be alternatively configured to provide visual and tactile signals as to which rotational direction is required to loosen adaptor 10. An adaptor of the present invention that provides visual and tactile signals as to which single rotational direction is correct is defined herein as unidirectional. This is very beneficial to a user when trying to install a faucet mounted water filter system onto a water faucet because the visual and tactile signals simplify and expedite the installation of the adaptor by eliminating uncertainty about the correct rotation of the adaptor that is required. In addition, body 12 may be fabricated such that it has a top surface 19 that is configured to be level or linear (i.e., no curvature) such that a user may use the top surface to align the adaptor in an orientation that permits easy threading of the adaptor onto the faucet during the installation of the water filter system.

As shown in FIG. 6, the curvature of gripping areas 50, essentially are located between pressure bearing face 54 and non-pressure bearing face 56, may be further defined by a depth (D) of gripping areas 50, a radius (B) of non-pressure bearing face, and a conic arc. The conic arc may comprise a RHO value (A) and an angle λ of the conic arc's trailing edge. In the exemplary embodiment, depth (D) may range from about 0.115 inches to about 0.220 inches, radius (B) may range from about 0.3 inches to about 1.5 inches, RHO value (A) may range from about 0.5 to about 0.75, and angle λ may range an angle from about 130 degrees to about 190 degrees. In one exemplary embodiment, depth (D) is about 0.1 inches, radius (B) is about 1.0 inches, RHO value (A) is about 0.5, radius (B) is about 1.0 inches, and angle λ is about 175 degrees. As shown, this exemplary embodiment comprises gripping areas having a smooth, curvilinear shape. However, it is understood that gripping areas 50, including pressure bearing and non-pressure bearing faces 54 and 56, may comprise other curvilinear, linear, non-linear, or any other shape as known to one of ordinary skill in the art.

The plurality of pressure bearing faces 54 may be positioned or spaced-apart from each other at a variety of intervals along circumference 11. For example, each pressure bearing face of the plurality of pressure bearing faces may be spaced from each other at an angle θ of from about 1 degree to about 180 degrees, alternatively from about 30 degrees to about 90 degrees. In the exemplary embodiment shown in FIGS. 1-6, angle θ is about 90 degrees between each pressure bearing face 54. It is understood that gripping areas 50 may have a variety of shapes and curvatures, including angular shapes that may provide an asymmetrical shape. Optionally, it is understood that gripping areas 50 may also have symmetrical shapes such as indents, grooves, nubs, protrusions, etc., that would still provide a means for a user to grip while turning the adaptor, but would no longer be unidirectional and thus would no longer provide a visual and tactile signal to the user as to the proper rotational direction.

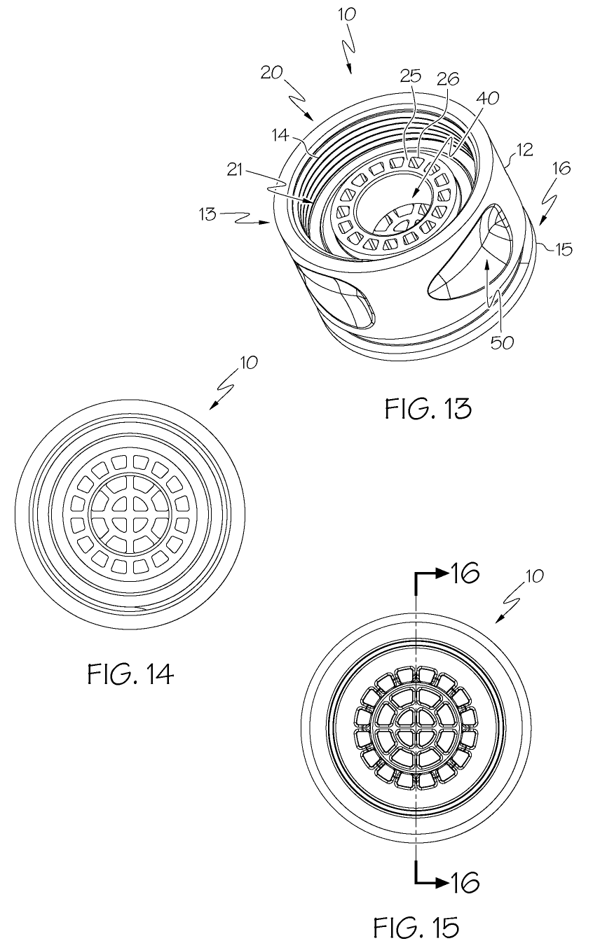

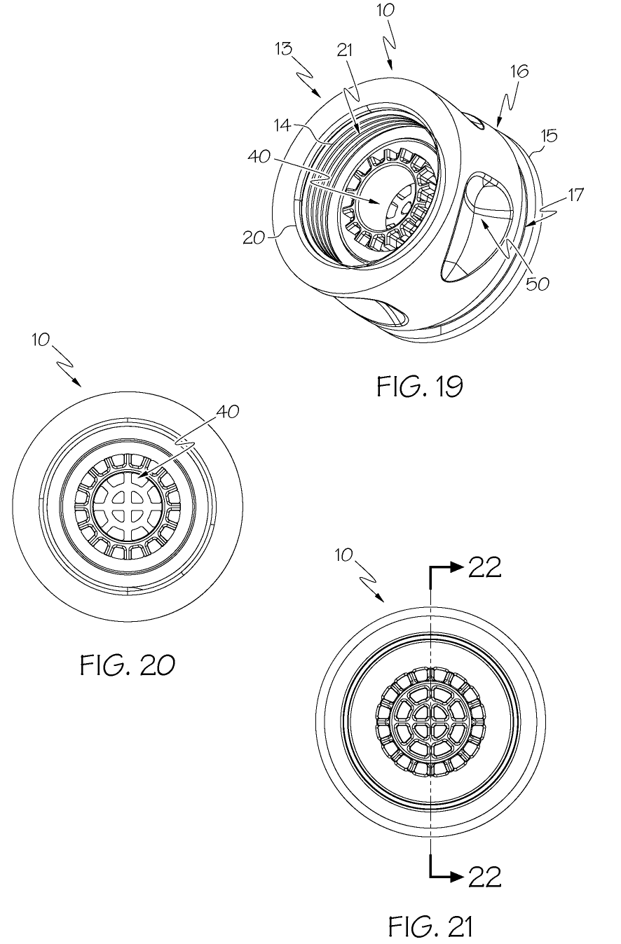

FIGS. 7-12 show another exemplary embodiment of adaptor 10, wherein body 12 has a shorter length than that shown in FIGS. 1-6. In addition, outer radial ribs 25 are shown extending longitudinally from bottom wall 22. More specifically, outer radial ribs 25 are not flush with outer annular rib 23. As shown, the portion of outer flow channels 26 extended longitudinally above bottom wall 22 are open, i.e., not closed by outer annular rib 24, thus permitting ribs 25 to trap the water flow within first inlet chamber 21 and direct it into and through the outer flow channels 26. Referring to FIGS. 13-18, another exemplary embodiment of adaptor 10 is shown. Adaptor 10 comprises internal threads 14 disposed at threaded end 13 and outer flow channels 26 are and outer radial ribs 25 and outer annular rib 24 are flush with each other but do extend longitudinally a distance from bottom wall 22. FIGS. 19-24 shown another exemplary embodiment of adaptor 10, wherein threaded end 13 comprises internal threading 14. Additionally, similar to the embodiment shown in FIGS. 7-12, adaptor 10 comprises outer radial ribs 25 that extend longitudinally from bottom wall 22. More specifically, outer radial ribs 25 are not flush with outer annular rib 23. As shown, the portion of outer flow channels 26 extended longitudinally above bottom wall 22 are open, i.e., not closed by outer annular rib 24, thus permitting ribs 25 to trap the water flow within first inlet chamber 21 and direct it into and through the outer flow channels 26.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An adaptor, comprising:
a body;
a threaded end connected to the body for threadingly engaging an end of a water faucet;
a flanged end connected to the body, opposite the threaded end for receiving a quick connect device on a faucet-mounted water filter system;
a water inlet disposed within the body at the threaded end, the water inlet comprising a first inlet chamber and an second inlet chamber in fluid communication with the first inlet chamber;
a water outlet disposed within the body at the flanged end;
a plurality of outer flow channels coaxially-aligned with a longitudinal axis of body 12, the plurality of outer flow channels connecting in fluid communication the first inlet chamber with the outlet; and
a plurality of inner flow channels that are coaxially-aligned with the longitudinal axis, the plurality of inner flow channels connecting in fluid communication the second inlet chamber with the outlet, wherein the plurality of inner flow channels are substantially concentric with the plurality of outer flow channels.

2. The adaptor according to claim 1, wherein the plurality of outer flow channels are evenly spaced about the longitudinal axis.

3. The adaptor according to claim 1, wherein the plurality of inner flow channels are evenly spaced about the longitudinal axis.

4. The adaptor according to claim 1, further comprising a plurality of gripping areas disposed along a circumference of the body, wherein the plurality of gripping areas provides visual and tactile directional signals as to the rotational direction required to attach or detach the adaptor to or from a threaded member.

5. The adaptor according to claim 4, wherein each of the gripping areas comprises a pressure-bearing face and a non-pressure-bearing face.

6. The adaptor according to claim 5, wherein the pressure-bearing face and the non-pressure-bearing face each has an angle of leverage, and wherein the angle of leverage of the non-pressure-bearing face is less than the angle of leverage of the pressure-bearing face.

7. The adaptor according to claim 1, wherein the adaptor is configured to attach a water filter system to a water faucet.

8. The adaptor according to claim 4, wherein each of the gripping areas is asymmetrical relative to any plane that contains the longitudinal axis of the adaptor.

9. The adaptor according to claim 4, wherein the body is asymmetrical relative to any plane that contains the longitudinal axis of the adaptor.

10. The adaptor according to claim 4, wherein each of the gripping areas is defined by an angle α of leverage from about 30 degrees to about 90 degrees for the pressure bearing faces and an angle P from about 10 degrees to about 60 degrees for the non-pressure-bearing faces.

11. The adaptor according to claim 10, wherein the gripping areas include a curvature that is defined by a finger recess depth (D) that ranges from about 0.115 inches to about 0.220 inches and a conic arc, and wherein the conic arc is further defined by a RHO value of the conic arc that ranges from about 0.5 to about 0.75, an angle λ of the conic arc trailing edge that ranges from about 130 degrees to about 190 degrees, and a radius (B) of the non-pressure bearing face that ranges from about 0.3 inches to about 1.5 inches.

12. The adaptor according to claim 4, wherein the gripping areas include at least a partially textured surface.

13. The adaptor according to claim 4, wherein the gripping areas have a surface comprising a low durometer plastic.

14. An asymmetrical adaptor for attaching a water filter system to a water supply, comprising:
a body, wherein the body is asymmetrical with respect to any plane that contains the longitudinal axis of the adaptor body;
a plurality of unidirectional gripping areas circumferentially positioned along a perimeter of the body;
a threaded end connected to the body for threadingly engaging an end of a water supply;
a flanged end connected to the body, opposite the threaded end for receiving a quick connect device on a faucet-mounted water filter system;
a water inlet disposed within the body at the threaded end; and
a water outlet disposed within the body at the flanged end and in fluid communication with the water inlet.

15. The adaptor according to claim 14, wherein each of the gripping areas comprises a pressure-bearing face and a non-pressure-bearing face.

16. A method for providing an adaptor with visual and tactile signals for attaching the adaptor to a threaded member, comprising:
providing an adaptor body; and
forming a plurality of unidirectional gripping areas along a circumference of the body such that the plurality of gripping areas provides visual and tactile directional signals as to the correct rotational direction required to attach the adaptor to a threaded member.

17. The method according to claim 16, wherein each of the gripping areas comprises a pressure-bearing face and a non-pressure-bearing face.

18. The method according to claim 17, further comprising forming the non-pressure bearing face with an angle of leverage that is less than an angle of leverage of the pressure bearing face.

19. An adaptor, comprising:
an annular body;
a threaded end connected to the body for threadingly engaging an end of a water faucet;
a flanged end connected to the body, opposite the threaded end for receiving a quick connect device on a faucet-mounted water filter system;
a water inlet disposed within the body at the threaded end;
an inlet chamber coaxially disposed within the annular body;
a plurality of outer ribs extending radially inwardly from the annular body to the water inlet chamber forming a plurality of outer flow channels;
a plurality of ribs disposed at an exit end of the inlet chamber forming a plurality of inner flow channels; and
an outlet disposed at the flanged end of the body;
wherein the plurality of outer flow channels connect in fluid communication the inlet to the outlet, and wherein the plurality of inner flow channels connect in fluid communication the inlet chamber with the outlet.

20. The adaptor according to claim 19, further comprising
an outer annular rib disposed coaxially with and within the annular body, the outer annular rib having a face that is transverse to the water flow path within the body; and
an inner annular rib disposed interior to the outer annular rib and coaxially with and within the annular body, the inner annular rib having a face that is transverse to the water flow path within the body.

21. The adaptor according to claim 20, wherein the plurality of outer ribs extend radially between the outer annular rib and the inner annular rib to form the plurality of outer flow channels.
